(19) United States
(12) Patent Application Publication
(10) Pub. No.: US 2023/0206589 A1
(43) Pub. Date: Jun. 29, 2023

(54) APPARATUS AND METHOD FOR DETECTING OBJECT USING OBJECT BOUNDARY LOCALIZATION UNCERTAINTY AWARE NETWORK AND ATTENTION MODULE

(71) Applicant: POSTECH Research and Business Development Foundation, Pohang-si (KR)

(72) Inventors: Dai Jin KIM, Pohang-si (KR); Sang Hun PARK, Pohang-si (KR)

(73) Assignee: POSTECH Research and Business Development Foundation, Pohang-si (KR)

(21) Appl. No.: 17/739,018

(22) Filed: May 6, 2022

(30) Foreign Application Priority Data
Dec. 24, 2021 (KR) 10-2021-0187146

(51) Int. Cl. G06V 10/44; G06T 7/73; G06V 10/82; G06V 10/774; G06V 10/776

(52) U.S. Cl. CPC G06V 10/44; G06T 7/73; G06V 10/82; G06V 10/774; G06V 10/776; G06T 2207/20081; G06T 2207/20084

(57) ABSTRACT

A method of detecting an object using an object boundary localization uncertainty aware network and an object boundary localization uncertainty attention module may comprise: calculating a convolutional feature from a single image through a convolutional neural network of an existing object detection neural network and then learning a classification and location of an object to detect the object; inputting an obtained localization value and a ground truth value of the object to the object boundary localization uncertainty aware network to learn an object boundary localization uncertainty; calculating, by the object boundary localization uncertainty attention module, an object boundary feature using the obtained object boundary localization uncertainty and training an object detection correction neural network using the object boundary feature; and aggregating an existing object detection result and a correction result to calculate a final object detection result.

### CROSS-REFERENCE TO RELATED APPLICATIONS

This application claims priority to Korean Patent Application No. 10-2021-0187146, filed on Dec. 24, 2021, with the Korean Intellectual Property Office (KIPO), the entire contents of which are hereby incorporated by reference.

### BACKGROUND

### 1. Technical Field

Exemplary embodiments of the present disclosure relate in general to a technology for detecting an object using an object boundary localization uncertainty aware network and an object boundary localization uncertainty attention module and, more specifically, to an apparatus and method for detecting an object using an object boundary localization uncertainty aware network and a correction technique based on an uncertainty result.

### 2. Related Art

An object detection technology is a core technology that can be applied to various application fields such as robots, video surveillance, and vehicle safety. With the development of convolutional neural networks, object detection technologies employing a single image have made a remarkable advance lately. Object detection technologies which have a high object detection rate while using a convolutional neural network are generally based on a grid cell method or a dense key point method.

According to an object detection method based on a grid cell method, convolutional features of an overall single image are calculated through a convolutional neural network, and an area extraction method is used for each of grid spaces corresponding to the obtained convolutional features to extract a convolutional feature. According to the area extraction method, each grid space is divided into extraction areas having a predefined size, and then a maximum or average value is calculated for the divided areas and used. According to the grid cell method, a feature extraction area is predefined, and thus object detection performance varies according to the size or aspect ratio of the extraction area.

According to an object detection method based on a dense key point method, convolutional features of an overall single image are calculated using a convolutional neural network, and dense points of each of the obtained convolutional features are matched with an object. The dense points are densely distributed to each of layers of convolutional features having a pyramid structure and represent objects having sizes each allocated to the layers. According to the dense key point method, a feature extraction area is not defined in advance. Accordingly, it is unnecessary to consider object detection performance for defining a feature extraction area, and a neural network structure is simple. To make use of such an advantage, this method is used in developing an object detection technology according to the present disclosure.

According to current single image object detection technologies employing a convolutional neural network, the grid cell method or dense key point method is used for detecting an object without considering accuracy in localizing an object boundary. In particular, these technologies are widely used in various fields, but the accuracy has not reached human-level accuracy such that the technologies is not used in a safety field.

Also, existing convolutional neural networks only extract features of the classification and size of an object without considering accuracy in localizing the boundary of the object, and thus it is not possible to know which feature is effective in estimating the size of the object.

### SUMMARY

Accordingly, exemplary embodiments of the present disclosure are provided to substantially obviate one or more problems due to limitations and disadvantages of the related art.

Exemplary embodiments of the present disclosure provide a function of outputting accuracy in localizing an object boundary detected in a single image by developing a program for outputting accuracy in localizing an object boundary.

Exemplary embodiments of the present disclosure also provide a technology for accurately detecting an object by emphasizing features that are effective in estimating the size of the object using such accuracy in localizing an object boundary.

According to an exemplary embodiment of the present disclosure for achieving the above-described objective, an apparatus for detecting an object using an object boundary localization uncertainty aware network and an object boundary localization uncertainty attention module may comprise: a processor; and a memory configured to store at least one command to be executed through the processor, wherein the at least one command causes the processor to perform: calculating a convolutional feature from a single image through a convolutional neural network of an existing object detection neural network and then learning a classification and location of an object to detect the object; inputting an obtained localization value and a ground truth value of the object to the object boundary localization uncertainty aware network to learn an object boundary localization uncertainty; calculating, by the object boundary localization uncertainty attention module, an object boundary feature using the obtained object boundary localization uncertainty and training an object detection correction neural network using the object boundary feature; and aggregating an existing object detection result and a correction result to calculate a final object detection result.

The apparatus of may further comprise an object boundary aware neural network including the existing object detection neural network, the object boundary localization uncertainty aware network, the object boundary localization uncertainty attention module, and the object detection correction neural network, wherein the object boundary aware neural network is trained, and the object boundary feature is reflected to an existing object center feature such that the object boundary localization uncertainty attention module accurately corrects an object detection result of the existing neural network.

The existing object detection neural network (fully convolutional one-stage (FCOS) object detection) may calculate a feature of the object through the convolutional neural network with a hierarchical structure (a feature pyramid network) and may detect the object through initial object classification and initial object regression.

The object boundary localization uncertainty aware network may be added to a portion of the existing object detection neural network for extracting an initial object regression and may be trained to output the object boundary localization uncertainty.

The object boundary localization uncertainty attention module may calculate the object boundary feature using the obtained object boundary localization uncertainty; input an object feature for detecting an initial object regression and calculate a feature of (4+1)C channels through a 1×1 neural network; and perform an element-wise multiplication between the obtained feature and an inverse value of the boundary localization uncertainty (1−uncertainty=certainty) and then calculate an object boundary feature having the same size as the initially input object feature through the 1×1 neural network.

The object detection correction neural network may learn a classification and location of the object using the obtained object boundary feature; set a classification learning target through an intersection over unit between an initially obtained boundary box and a ground truth value of the object; and set an object boundary learning target through an offset between the two boxes.

The apparatus may output a final object classification value through an element-wise multiplication between an object classification value of the object detection correction neural network and an object classification value of the existing object detection neural network, and output a final object boundary value through an element-wise sum between an object boundary value of the object detection correction neural network and an object boundary value of the existing object detection neural network.

According to another exemplary embodiment of the present disclosure for achieving the above-described objective, a method of detecting an object using an object boundary localization uncertainty aware network and an object boundary localization uncertainty attention module may comprise: calculating a convolutional feature from a single image through a convolutional neural network of an existing object detection neural network and then learning a classification and location of an object to detect the object; inputting an obtained localization value and a ground truth value of the object to the object boundary localization uncertainty aware network to learn an object boundary localization uncertainty; calculating, by the object boundary localization uncertainty attention module, an object boundary feature using the obtained object boundary localization uncertainty and training an object detection correction neural network using the object boundary feature; and aggregating an existing object detection result and a correction result to calculate a final object detection result.

The method may further comprise: training the object boundary localization uncertainty aware network; calculating the object boundary feature through the object boundary uncertainty attention module; and finally detecting the object using the object detection correction neural network.

The object boundary localization uncertainty aware network may learn a correlation between an object boundary localization value of the existing neural network and the ground truth value.

A negative log likelihood (NLL) function L_{Gaussian} (Equation 2) may be used to learn a standard deviation of a larger value with an increase in a difference between a localization value and the ground truth value and learn a standard deviation of a smaller value with a decrease in the difference.

A standard deviation may be learned with a value between 0 and 1 which represents an uncertainty of object boundary localization.

According to yet another exemplary embodiment of the present disclosure for achieving the above-described objective, a computer program stored in a computer-readable recording medium for implementing the method may be provided.

According to yet another exemplary embodiment of the present disclosure for achieving the above-described objective, a computer-readable recording medium for implementing a program of the method may be provided.

According to the present disclosure, it is possible to provide an object detection method employing an object boundary localization uncertainty aware network and an object boundary localization uncertainty attention module to express accuracy in localizing an object boundary in a single image and accurately detect the object.

Assuming that a result of localizing an object boundary tends to a normal distribution having a ground truth as an average value, an object boundary localization uncertainty aware network can learn standard deviation values according to localization results in a corresponding distribution and represent an object boundary localization uncertainty with a standard deviation learned using a characteristic that a standard deviation increases with an increase in the difference between a localization result and the ground truth and decreases with a reduction in the difference.

An object boundary localization uncertainty attention module can extract a feature that is effective in localizing the boundary of an object among feature points of each of convolutional features of a neural network using an object boundary localization uncertainty and is combined with an existing detection neural network to correct an object detection result of the existing detection neural network using the obtained feature. Accordingly, it is possible to have both advantages of object information that a convolutional feature of the existing detection neural network has and an object boundary feature obtained through an object boundary localization uncertainty aware network.

Since an existing convolutional neural network only extract features of the classification and size of an object without considering accuracy in localizing an object boundary, it is difficult to correct an object detection result. Accordingly, using an object boundary localization uncertainty allows extraction of a feature that is effective in object boundary localization, and it is possible to accurately detect an object by correcting an object detection result of an existing neural network using the feature.

### BRIEF DESCRIPTION OF DRAWINGS

FIG. 1 is a flowchart illustrating a process of detecting an object using an object boundary localization uncertainty aware network in an object detection method employing an object boundary localization uncertainty aware network and an object boundary localization attention module according to an exemplary embodiment of the present disclosure.

FIG. 2 is a conceptual diagram illustrating a method of learning an object boundary localization uncertainty by an object detection apparatus employing an object boundary localization uncertainty aware network and an object boundary localization uncertainty attention module according to an exemplary embodiment of the present disclosure.

FIG. 3 is a conceptual diagram in which an object detection apparatus employing an object boundary localization uncertainty aware network and an object boundary localization uncertainty attention module according to the exemplary embodiment of the present disclosure calculates an object boundary feature using a structure of the object boundary localization uncertainty aware network and an object boundary localization uncertainty.

FIG. 4 is a flowchart illustrating an object detection method employing an object boundary localization uncertainty aware network and an object boundary localization uncertainty attention module according to an exemplary embodiment of the present disclosure.

FIG. 5 is a configuration diagram of an object detection apparatus 1000 employing an object boundary localization uncertainty aware network and an object boundary localization uncertainty attention module according to an exemplary embodiment of the present disclosure.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term ‘and/or’ includes any and all combinations of one or more of the associated listed items.

In exemplary embodiments of the present disclosure, ‘at least one of A and B’ may refer to ‘at least one A or B’ or ‘at least one of one or more combinations of A and B’. In addition, ‘one or more of A and B’ may refer to ‘one or more of A or B’ or ‘one or more of one or more combinations of A and B’.

It will be understood that when an element is referred to as being ‘connected’ or ‘coupled’ to another element, it can be directly connected or coupled to the other element or intervening elements may be present. In contrast, when an element is referred to as being ‘directly connected’ or ‘directly coupled’ to another element, there are no intervening elements present. Other words used to describe the relationship between elements should be interpreted in a like fashion (i.e., ‘between’ versus ‘directly between,’ ‘adjacent’ versus ‘directly adjacent,’ etc.).

The terminology used herein is for the purpose of describing particular embodiments only and is not intended to be limiting of the present disclosure. As used herein, the singular forms ‘a,’ ‘an’ and ‘the’ are intended to include the plural forms as well, unless the context clearly indicates otherwise. It will be further understood that the terms ‘comprises,’ ‘comprising,’ includes' and/or ‘including,’ when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

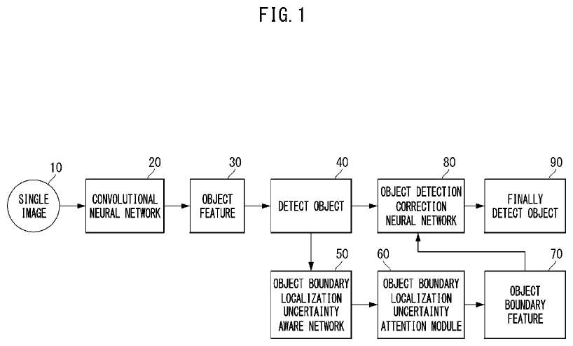

FIG. 1 is a flowchart illustrating a process of detecting an object using an object boundary localization uncertainty aware network in an object detection method employing an object boundary localization uncertainty aware network and an object boundary localization attention module according to an exemplary embodiment of the present disclosure.

Referring to FIG. 1, the object detection method may be performed by an object detection apparatus which employs an object boundary localization uncertainty aware network and an object boundary localization attention module according to the exemplary embodiment of the present disclosure and may include whole processes of an object detection technology which employs object detection method using an object boundary localization uncertainty aware network.

The object detection apparatus may include an object boundary localization uncertainty aware network 50, an object boundary localization uncertainty attention module 60, and an object detection correction neural network 80. In addition, the convolutional neural network 20 may further include a convolutional neural network 20.

In the object detection method, first, a convolutional feature 30 is calculated from a single image 10 through a convolutional neural network 20 of an existing object detection neural network, and then a classification and location of an object are learned through a convolutional neural network 20 of an existing object detection neural network. The classification and location of the object are used in obtaining a localization value of the object. That is, the convolutional neural network 20 may generate an object detection result 40 which inaccurate predictions that need to be compensated for by a convincing features for the boundaries of the bounding box (bbox).

Next, the obtained localization value and a ground truth of the object are input to an object boundary localization uncertainty aware network 50 to learn a boundary localization uncertainty. The learned result for the boundary localization uncertainty is passed to an object boundary localization uncertainty attention module 60.

Next, the object boundary localization uncertainty attention module 60 may calculate an object boundary feature 70 using the obtained object boundary localization uncertainty and may train an object detection correction neural network 80 with the object boundary feature 70 and the object detection result 40.

Finally, the object detection result 40 and a correction result are aggregated through the object detection correction neural network 80, thereby generating a final object detection result 90.

As described above, according to the present embodiment, the object detection result obtained from the existing convolutional neural network 30 is compensated through the object boundary localization uncertainty aware network 50, the boundary localization uncertainty attention module 60, and the object detection correction neural network 80 to generate a highly reliable final object detection result 90. That is, in the object detection method, the localization uncertainty-based attention may be designed to encode features from both the convincing regions for the boundaries of the bbox and the central region of the object and it may use the box confidence maps to enhance the original features by exploiting certain boundary features. In this embodiment, it is possible to effectively refine the coarse predictions through the above-described process.

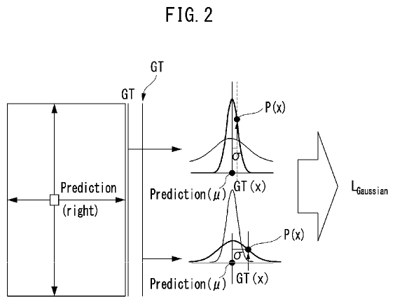

FIG. 2 is a conceptual diagram illustrating a method of learning an object boundary localization uncertainty by an object detection apparatus employing an object boundary localization uncertainty aware network and an object boundary localization uncertainty attention module according to an exemplary embodiment of the present disclosure.

Referring to FIG. 2, an object detection method employing an object boundary localization uncertainty aware network and an object boundary localization uncertainty attention module according to an exemplary embodiment of the present disclosure includes training an object boundary localization uncertainty aware network.

The object boundary localization uncertainty aware network learns a correlation between an object boundary localization value of an existing neural network and a ground truth value.

In this embodiment, localization uncertainty is modeled using each single Gaussian model of the bounding box (bbox) regression values (l, r, t, b) as well as the corresponding variances. A single variate Gaussian distribution P(x), which is a probability distribution function of a normal distribution having an object boundary ground truth value as an average value, may be used as a loss function:

$$P ( x ) = \frac{1}{\sqrt{2 π {σ}^{2}}} {e}^{\frac{{( x - μ )}^{2}}{2 {σ}^{2}}} \qquad [ Equation 1 ]$$

In Equation 1, μ denotes the predicted bbox regression, x denotes the bbox regression target, and σ (standard deviation) denotes the localization uncertainty, the value of which is (0, 1) with a sigmoid function. For training, a negative log likelihood (NLL) loss with Gaussian parameters is designed as follows:

$${{L}_{Gaussian} = - \frac{λ}{{N}_{p o s}} {\sum }_{x , y} {\sum }_{l , r , t , b} 〛}_{\{ {c}_{x , y}^{G} > 0 \}} log ( P ( 𝕏 ) ) \qquad [ Equation 2 ]$$

In Equation 2, [symbol] denotes (l^{G}, r^{G}, t^{G}, b^{G}) of four-directional bbox regression targets, and the corresponding Gaussian parameters μ and σ in Eq. (1) are also (μₗ, μᵣ, μₜ, μ_{b}) and σₗ, σᵣ, σₜ, σ_{b}), respectively. [symbol] _{{c}_{_{x,y}}_{^{G}}>0} is the indicator function, which is 1 if c_{x,y}^{G}>0 and 0 otherwise, and c_{x,y}^{G} denotes the classification label at the (x, y) pixel location of the feature. The summation is calculated over four-directional bbox regressions and positive samples. The cost average is calculated by dividing by the number of positive samples, Nₚₒₛ. λ (λ=0.2 in this paper) is the balance weight for L_{Gaussian}.

A negative log likelihood (NLL) function L_{Gaussian} (Equation 2) including a univariate Gaussian distribution (Equation 1), which is a probability distribution function of a normal distribution having an object boundary ground truth value as an average value on the basis of a loss function, is used to learn a standard deviation of a larger value with an increase in the difference between a localization value and a ground truth value and learn a standard deviation of a smaller value with a decrease in the difference.

A standard deviation is learned with a value between 0 and 1 which represents an uncertainty of object boundary localization.

In this embodiment, while not learning bbox regression only with L_{Gaussian}, the λ value of L_{Gaussian} can be set so that the standard deviation can be sufficiently learned while having an appropriate effect on bbox regression. According to L_{Gaussian}, localization uncertainty is predicted to involve larger σ values when there are larger gaps between the predicted regression and corresponding targets, and vice versa. Therefore, the object detection method may be used (1.0−uncertainty) as the four-directional box confidence at each pixel location.

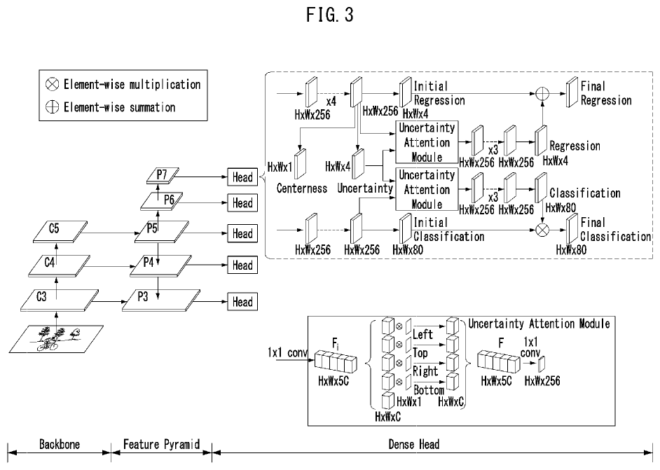

FIG. 3 is a conceptual diagram in which an object detection apparatus employing an object boundary localization uncertainty aware network and an object boundary localization uncertainty attention module according to the exemplary embodiment of the present disclosure calculates an object boundary feature using a structure of the object boundary localization uncertainty aware network and an object boundary localization uncertainty.

Referring to FIG. 3, the object detection apparatus employing an object boundary localization uncertainty aware network and an object boundary localization uncertainty attention module according to the exemplary embodiment of the present disclosure includes a structure of an object boundary aware network including several partial neural networks.

The object boundary aware network may include an existing object detection neural network, an object boundary localization uncertainty aware network, a boundary uncertainty attention module, and an object detection correction neural network.

The existing object detection neural network (fully convolutional one-stage (FCOS) object detection) calculates a feature of an object through a convolutional neural network with a hierarchical structure (feature pyramid network) and detects an object through initial object classification and initial object regression.

The object boundary localization uncertainty aware network is added to a part of the existing neural network for extracting an initial boundary of the object. The object boundary localization uncertainty aware network is trained as described with reference to FIG. 2 and outputs a boundary localization uncertainty of the object.

The boundary uncertainty attention module (Hereinafter, also referred to briefly as uncertainty attention module) includes a method of calculating a boundary feature of the object using the obtained boundary localization uncertainty of the object.

More specifically, the dense key points-based detector typically focuses on the area at the center of the object, as this usually ensures powerful feature representation for predictions. Accordingly, the pixel location with the maximum classification score within the central area may be selected as the final key point location for initial predictions. However, the convincing regions for the boundaries of the bbox are maintained strong representation for bbox regression from the obtained box confidence maps. Occasionally, such features can also be better representations for classification than the center feature of the object in cases of occlusion by the background or unusually shaped objects. This means that in this embodiment, initial predictions focusing on the center region of the object can be compensated by exploiting the convincing features for the boundaries of the bbox, indicated by localization uncertainty.

Therefore, in the present embodiment, it is provided that the uncertainty attention module (UAM), which is a novel feature refinement module that leverages box confidence maps as spatial attentions. As shown in FIG. 3, the UAM takes the last feature of the initial prediction as input, then generates a feature Fᵢ with (4+1)C channels through the 1×1 convolution layer. The 4C channels of Fᵢ correspond to the box confidence map of each boundary, while the other 1C channels of Fᵢ correspond to the original feature representing the central area of the object. Each box confidence map is multiplied spatially to the corresponding Fᵢ, then all the features are concatenated. The concatenated feature F can be formulated using the following equation:

$$F = \{ \begin{matrix}{F}_{ic} ⊗ ( 1. - U ( L ) ) , & 0 \leq c < C \\ {F}_{ic} ⊗ ( 1. - U ( T ) ) , & C \leq c < 2 C \\ {F}_{ic} ⊗ ( 1. - U ( R ) ) , & 2 C \leq c < 3 C \\ {F}_{ic} ⊗ ( 1. - U ( B ) ) , & 3 C \leq c < 4 C \\ {F}_{ic} , & 4 C \leq c < 5 C\end{matrix} \qquad [ Equation 3 ]$$

In Equation 3, c denotes the feature channel and U(L), U(T), U(R) and U(B) respectively denote the localization uncertainties of the left, top, right and bottom. Finally, the UAM may produce an output feature with the same shape as the input feature through a 1×1 convolution layer. In this embodiment, C=256 may be applied for the classification refinement branch and C=64 may be applied for the bbox regression refinement branch.

Referring back to FIG. 3, in the overall network architecture of the uncertainty-aware dense detector (UADET), the structures of the backbone and the feature pyramid network (FPN) may be the same as those of the existing technology, but the head structure is different. First, the localization uncertainty prediction is attached to the initial bbox regression branch. Then, additional sub-branches are attached for classification and bbox regression refinement using the UAM, which leverages localization uncertainty. Each sub-branch refines the feature through the UAM, and finally applies 3×3 convolution layers to produce the prediction to be refined. The UADET predicts final classification and bbox regression by combining the existing and refined results.

The sub-branches may be modeled as a generated anchor refinement problem. The initial bbox prediction may be served as an anchor generated from the pixel location of the feature. Next, the classification label may be obtained by measuring the intersection over unit (IoU) between the generated anchor and the ground truth boxes. The classification label of the ground truth box, which has a maximum IoU with the generated anchor, is the label of the anchor. If the maximum IoU is under 0.6, that anchor may be treated as the background. Focal loss may be adopt for classification refinement branch.

Focal loss may correspond to the local sum of the classification score and target for refinement divided by the number of positive samples from the above classification targeting strategy. For positive samples, the generated anchor may be compensated by the offset to the assigned ground truth box. The sub-branch for bbox regression refinement learns the offset through L1 loss.

As described above, the uncertainty attention module inputs an object feature for detecting the initial boundary of the object and calculates a feature of (4+1)C channels through a 1×1 neural network. An element-wise multiplication is performed between the obtained feature and an inverse value of the boundary localization uncertainty (1−uncertainty=certainty), and then an object boundary feature having the same size as the initially input object feature is calculated through the 1×1 neural network. The object detection correction neural network learns a classification and location of the object using the obtained object boundary feature.

Unlike the existing neural network, the object detection correction neural network sets a classification learning target through an intersection over unit between an initially obtained boundary box and a ground truth value of the object and sets an object boundary learning target through an offset between the two boxes. An element-wise multiplication is performed between an object classification value of the object detection correction neural network and an object classification value of the existing neural network to output a final object classification value, and an element-wise sum is performed between an object boundary value of the object detection correction neural network and an object boundary value of the existing neural network to output a final object boundary value.

A trained object boundary localization uncertainty aware network accurately corrects an object detection result of the existing neural network by reflecting the object boundary feature to an existing object center feature. Verification of this has been completed through a known object detection accuracy measurement method.

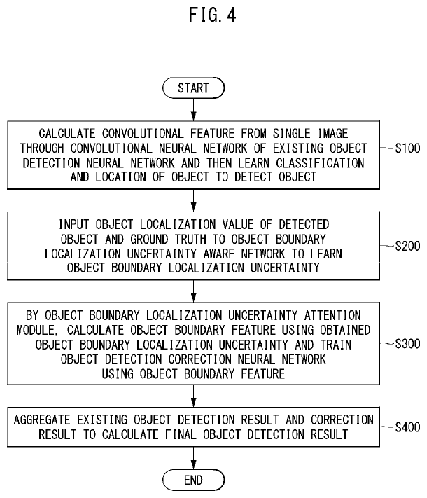

FIG. 4 is a flowchart illustrating an object detection method employing an object boundary localization uncertainty aware network and an object boundary localization uncertainty attention module according to an exemplary embodiment of the present disclosure.

The object detection method employing an object boundary localization uncertainty aware network and an object boundary localization uncertainty attention module according to the exemplary embodiment of the present disclosure includes following operations S100 to S400.

In operation S100, the object detection method may include calculating a convolutional feature from a single image through a convolutional neural network of an existing object detection neural network and then learning a classification and location of an object to detect the object.

In operation S200, the object detection method may include inputting an obtained localization value and a ground truth value of the object to the object boundary localization uncertainty aware network to learn a boundary localization uncertainty.

In operation S300, the object boundary localization uncertainty attention module may calculate an object boundary feature using the obtained object boundary localization uncertainty and may train an object detection correction neural network using the object boundary feature.

In operation S400, the object detection method may include aggregating an existing object detection result and a correction result and may generate a final object detection result.

Furthermore, the object detection method employing an object boundary localization uncertainty aware network and an object boundary localization uncertainty attention module according to the exemplary embodiment of the present disclosure may additionally include specific operation procedures rerated to operation S400.

The object detection method may including an operation of training the object boundary localization uncertainty aware network, an operation of calculating an object boundary feature through the object boundary localization uncertainty attention module, and an operation of finally detecting an object using the object detection correction neural network.

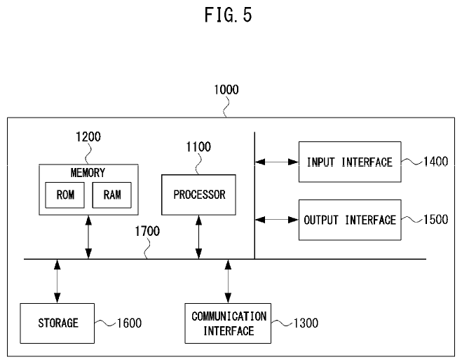

FIG. 5 is a configuration diagram of an object detection apparatus 1000 employing an object boundary localization uncertainty aware network and an object boundary localization uncertainty attention module according to an exemplary embodiment of the present disclosure.

Referring to FIG. 5, the object detection apparatus 1000 employing an object boundary localization uncertainty aware network and an object boundary localization uncertainty attention module according to the exemplary embodiment of the present disclosure may include a processor 1100, a memory 1200, a transceiver 1300, an input interface 1400, an output interface 1500, a storage 1600, and a bus 1700.

The object detection apparatus 1000 employing an object boundary localization uncertainty aware network and an object boundary localization uncertainty attention module according to the exemplary embodiment of the present disclosure includes the processor 1100 and the memory 1200 in which at least one command to be executed through the processor 1100 is stored. The at least one command causes the processor 1100 to perform an operation (refer to S100 of FIG. 4) of calculating a convolutional feature from a single image through a convolutional neural network of an existing object detection neural network and then learning a classification and location of an object to detect the object, an operation (refer to S200 of FIG. 4) of inputting an obtained localization value and a ground truth value of the object to the object boundary localization uncertainty aware network to learn a boundary localization uncertainty, an operation (refer to S300 of FIG. 4) in which the object boundary localization uncertainty attention module calculates an object boundary feature using the obtained object boundary localization uncertainty and trains an object detection correction neural network using the object boundary feature, and an operation (refer to S400 of FIG. 4) of aggregating an existing object detection result and a correction result to calculate a final object detection result.

The processor 1100 may be a central processing unit (CPU), a graphics processing unit (GPU), or a dedicated processor whereby methods according to exemplary embodiments of the present disclosure are performed.

Each of the memory 1200 and the storage 1600 may be configured using at least one of a volatile storage medium and a non-volatile storage medium. For example, the memory 1200 may be configured using at least one of a read-only memory (ROM) and a random access memory (RAM).

The object detection apparatus 1000 employing an object boundary localization uncertainty aware network and an object boundary localization uncertainty attention module according to the exemplary embodiment of the present disclosure may include the transceiver 1300 that performs communication through a wireless network.

The object detection apparatus 1000 employing an object boundary localization uncertainty aware network and an object boundary localization uncertainty attention module according to the exemplary embodiment of the present disclosure may additionally include the input interface 1400, the output interface 1500, the storage 1600, etc.

The elements included in the object detection apparatus 1000 employing an object boundary localization uncertainty aware network and an object boundary localization uncertainty attention module may be connected through the bus 1700 and communicate with each other.

Examples of the object detection apparatus 1000 employing an object boundary localization uncertainty aware network and an object boundary localization uncertainty attention module according to the exemplary embodiment of the present disclosure may be a desktop computer, a laptop computer, a notebook, a smart phone, a tablet personal computer (PC), a mobile phone, a smart watch, smart glasses, an e-book reader, a portable multimedia player (PMP), a portable game machine, a navigation apparatus, a digital camera, a digital multimedia broadcasting (DMB) player, a digital audio recorder, a digital audio player, a digital video recorder, a digital video player, a personal digital assistant (PDA), etc. which can perform communication.

According to the present disclosure, it is possible to provide an object detection method employing an object boundary localization uncertainty aware network and an object boundary localization uncertainty attention module to express accuracy in localizing an object boundary in a single image and accurately detect the object.

Assuming that a result of localizing an object boundary tends to a normal distribution having a ground truth as an average value, an object boundary localization uncertainty aware network can learn standard deviation values according to localization results in a corresponding distribution and represent an object boundary localization uncertainty with a standard deviation learned using a characteristic that a standard deviation increases with an increase in the difference between a localization result and the ground truth and decreases with a reduction in the difference.

An object boundary localization uncertainty attention module can extract a feature that is effective in localizing the boundary of an object among feature points of each of convolutional features of a neural network using an object boundary localization uncertainty and is combined with an existing detection neural network to correct an object detection result of the existing detection neural network using the obtained feature. Accordingly, it is possible to have both advantages of object information that a convolutional feature of the existing detection neural network has and an object boundary feature obtained through an object boundary localization uncertainty aware network.

Since an existing convolutional neural network only extract features of the classification and size of an object without considering accuracy in localizing an object boundary, it is difficult to correct an object detection result. Accordingly, using an object boundary localization uncertainty allows extraction of a feature that is effective in object boundary localization, and it is possible to accurately detect an object by correcting an object detection result of an existing neural network using the feature.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An apparatus for detecting an object using an object boundary localization uncertainty aware network and an object boundary localization uncertainty attention module, the apparatus comprising:
a processor; and
a memory configured to store at least one command to be executed through the processor,
wherein the at least one command causes the processor to perform:
calculating a convolutional feature from a single image through a convolutional neural network of an existing object detection neural network and then learning a classification and location of an object to detect the object;
inputting an obtained localization value and a ground truth value of the object to the object boundary localization uncertainty aware network to learn an object boundary localization uncertainty;
calculating, by the object boundary localization uncertainty attention module, an object boundary feature using the obtained object boundary localization uncertainty and training an object detection correction neural network using the object boundary feature; and
aggregating an existing object detection result and a correction result to calculate a final object detection result.

2. The apparatus of claim 1, further comprising an object boundary aware neural network including the existing object detection neural network, the object boundary localization uncertainty aware network, the object boundary localization uncertainty attention module, and the object detection correction neural network,
wherein the object boundary aware neural network is trained, and the object boundary feature is reflected to an existing object center feature such that the object boundary localization uncertainty attention module accurately corrects an object detection result of the existing neural network.

3. The apparatus of claim 1, wherein the existing object detection neural network (fully convolutional one-stage (FCOS) object detection) calculates a feature of the object through the convolutional neural network with a hierarchical structure (a feature pyramid network) and detects the object through initial object classification and initial object regression.

4. The apparatus of claim 1, wherein the object boundary localization uncertainty aware network is added to a portion of the existing object detection neural network for extracting an initial object regression and is trained to output the object boundary localization uncertainty.

5. The apparatus of claim 1, wherein the object boundary localization uncertainty attention module calculates the object boundary feature using the obtained object boundary localization uncertainty,
inputs an object feature for detecting an initial object regression and calculates a feature of (4+1)C channels through a 1×1 neural network, and
performs an element-wise multiplication between the obtained feature and an inverse value of the boundary localization uncertainty (1−uncertainty=certainty) and then calculates an object boundary feature having the same size as the initially input object feature through the 1×1 neural network.

6. The apparatus of claim 1, wherein the object detection correction neural network learns a classification and location of the object using the obtained object boundary feature,
sets a classification learning target through an intersection over unit between an initially obtained boundary box and a ground truth value of the object, and
sets an object boundary learning target through an offset between the two boxes.

7. The apparatus of claim 1, wherein the apparatus outputs a final object classification value through an element-wise multiplication between an object classification value of the object detection correction neural network and an object classification value of the existing object detection neural network, and
outputs a final object boundary value through an element-wise sum between an object boundary value of the object detection correction neural network and an object boundary value of the existing object detection neural network.

8. A method of detecting an object using an object boundary localization uncertainty aware network and an object boundary localization uncertainty attention module, the method comprising:
calculating a convolutional feature from a single image through a convolutional neural network of an existing object detection neural network and then learning a classification and location of an object to detect the object;
inputting an obtained localization value and a ground truth value of the object to the object boundary localization uncertainty aware network to learn an object boundary localization uncertainty;
calculating, by the object boundary localization uncertainty attention module, an object boundary feature using the obtained object boundary localization uncertainty and training an object detection correction neural network using the object boundary feature; and
aggregating an existing object detection result and a correction result to calculate a final object detection result.

9. The method of claim 8, further comprising:
training the object boundary localization uncertainty aware network;
calculating the object boundary feature through the object boundary uncertainty attention module; and
finally detecting the object using the object detection correction neural network.

10. The method of claim 8, wherein the object boundary localization uncertainty aware network learns a correlation between an object boundary localization value of the existing neural network and the ground truth value.

11. The method of claim 8, wherein a univariate Gaussian distribution (Equation 1), which is a probability distribution function of a normal distribution having an object boundary ground truth value as an average value, is used as a loss function:
$$P ( x ) = \frac{1}{\sqrt{2 π {σ}^{2}}} {e}^{\frac{{( x - μ )}^{2}}{2 {σ}^{2}}} \qquad ( Equation 1 )$$

12. The method of claim 8, wherein a negative log likelihood (NLL) function L_{Gaussian} (Equation 2) is used to learn a standard deviation of a larger value with an increase in a difference between a localization value and the ground truth value and learn a standard deviation of a smaller value with a decrease in the difference:
$${{L}_{Gaussian} = - \frac{λ}{{N}_{p o s}} {\sum }_{x , y} {\sum }_{l , r , t , b} 〛}_{\{ {c}_{x , y}^{G} > 0 \}} log ( P ( 𝕏 ) ) \qquad ( Equation 2 )$$

13. The method of claim 8, wherein a standard deviation is learned with a value between 0 and 1 which represents an uncertainty of object boundary localization.
